(19) United States
(12) Patent Application Publication
(10) Pub. No.: US 2008/0044695 A1
(43) Pub. Date: Feb. 21, 2008

(54) REFORMER SYSTEM

(76) Inventor: Andreas KAUPERT, Esslingen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/762,284

(22) Filed: Jun. 13, 2007

(30) Foreign Application Priority Data
Jun. 22, 2006 (DE) 10 2006 028 699.5

(51) Int. Cl. H01M 8/18; H01M 8/04

(52) U.S. Cl. 429/17; 429/20

(57) ABSTRACT

A reformer system for generating a hydrogen-containing gas for a fuel cell system, especially in a motor vehicle, includes an evaporator arrangement (12) to be fed with hydrocarbon and mixed material for generating a hydrocarbon vapor/mixed material mixture, and a reformer arrangement (14) with reformer catalytic converter material (40, 42) for converting the hydrocarbon vapor/mixed material mixture to hydrogen-containing gas. The reformer arrangement (14) is surrounded by a mixed material flow space (22), through which at least a part of the mixed material to be introduced into the evaporator arrangement (12) can flow for the transmission of heat between the reformer arrangement (14) and the mixed material. An ignition arrangement (52) is assigned to the mixed material flow space (22) for igniting and burning the mixed material flowing through same in the mixed material flow space.

### CROSS REFERENCE TO RELATED APPLICATIONS

This application claims the benefit of priority under 35 U.S.C. § 119 of German Patent Application DE 10 2006 028 699.5 filed Jun. 22, 2006, the entire contents of which are incorporated herein by reference.

### FIELD OF THE INVENTION

The present invention pertains to a reformer system for generating a hydrogen-containing gas for a fuel cell system, especially in a motor vehicle, comprising an evaporator arrangement to be fed with hydrocarbon and mixed material for generating a hydrocarbon vapor/mixed material mixture, a reformer arrangement with reformer catalytic converter material for converting the hydrocarbon vapor/mixed material mixture to hydrogen-containing gas, whereby the reformer arrangement is surrounded by a mixed material flow space, through which at least a part of the mixed material to be introduced into the evaporator arrangement can flow for the transmission of heat between the reformer arrangement and the mixed material. Furthermore, the present invention pertains to a process for operating such a reformer system.

### BACKGROUND OF THE INVENTION

A reformer system of this type has become known from DE 10 2004 020 507 A1. In this reformer system, the mixed material, which is essentially composed of air and fuel cell exhaust gas, i.e., anode exhaust gas, flows through the mixed material flow space and thus along the outside of the reformer arrangement, in which this mixed material, which is thoroughly mixed with hydrocarbon vapor, is then also converted into a hydrogen-containing gas, which is generally also designated as reformate. Some of the heat forming during this conversion process can be transmitted to the mixed material flowing in the mixed material flow space, so that this mixed material can be introduced, preheated, into the reformer arrangement, and thus, a stable reforming process can be guaranteed at suitable temperatures.

One problem with this arrangement is that, in the start phase of the reformer system, i.e., at the beginning of the conversion process, the mixed material already flows through the mixed material flow space and also in this phase, heat is already drawn from the area of the reformer arrangement. In this phase, however, the reformer arrangement has not yet reached the operating temperature needed for a stable conversion process, such that the reaching of the process temperature is delayed by the flowing about of the reformer arrangement with the comparatively cold mixed material.

Introducing a fuel stream, i.e., a hydrocarbon stream, and a mixed material stream into a reformer arrangement has become known from DE 103 59 231 A1. The mixed material stream, which is essentially composed of air and anode exhaust gas, is ignited and burned in a reaction chamber lying in front of a reaction space of the reformer arrangement, in which the reformate is produced. In this way, in this state of the art, the water content contained in the mixed material, i.e., in the mixture of anode exhaust gas and air, shall be increased, and thus, the reforming efficiency in the reaction space shall be increased.

### SUMMARY OF THE INVENTION

The object of the present invention is to perfect a reformer system of this type, such that the start phase of the reforming process can be shortened with a simple design.

According to the present invention, this object is accomplished by a reformer system for generating a hydrogen-containing gas for a fuel cell system, especially in a motor vehicle, comprising an evaporator arrangement to be fed with hydrocarbon and mixed material for generating a hydrocarbon vapor/mixed material mixture, a reformer arrangement with reformer catalytic converter material for converting the hydrocarbon vapor/mixed material mixture into hydrogen-containing gas, whereby the reformer arrangement is surrounded by a mixed material flow space, through which at least a part of the mixed material to be introduced into the evaporator arrangement can flow for the transmission of heat between the reformer arrangement and the mixed material.

This system is further characterized in that an ignition arrangement is assigned to the mixed material flow space for igniting and burning the mixed material flowing through same in the mixed material flow space.

In the design of a reformer system according to the present invention, due to the combustion of the mixed material occurring in thermal interaction with the reformer arrangement, it is ensured that no heat is withdrawn, above all, in the start phase of the reforming of the reformer arrangement proper, but rather the reformer arrangement and the reformer catalytic converter material arranged therein are additionally heated by the heat forming during the combustion of the mixed material. This leads to a distinctly faster rise in the temperature of the reformer catalytic converter material to the needed process temperature, in order to then be able to carry out a stable reforming process for generating a hydrogen-containing gas. Furthermore, the heat forming during this combustion is also used for the mixed material and the combustion gases forming during the combustion of the mixed material to be able to be introduced into the reformer arrangement with a higher temperature, which contributes to the stabilization of the mixture formation (“cold flame”). Furthermore, water is produced during this combustion, which is introduced together with the other combustion gases and components into the reformer arrangement and is converted into hydrogen during the catalytic reaction and also contributes to the reduction of soot formation. After reaching this process temperature, the combustion can then be completed in the area of the mixed material flow space, so that subsequently heat can be taken up by the reformer arrangement due to this mixed material coming through, i.e., can cool same, in order to prevent an excessive rise in temperature beyond the suitable process temperature.

For example, a feed device may be provided for feeding air and anode exhaust gas from a fuel cell system as mixed material or mixed material component through the mixed material flow space. Furthermore, the present invention pertains to a process for operating a reformer system according to the present invention, in which process air and anode exhaust gas of a fuel cell system as mixed material or mixed material component is burned in the mixed material flow space and is forwarded to the evaporator arrangement, whereby the air is supplied with such excess regarding the anode exhaust gas that during the subsequent thorough mixing of the air introduced into the evaporator arrangement with hydrocarbon vapor, a hypostoichiometric air/hydrocarbon vapor mixture ratio is produced.

Thus, it is important here that even if mixed material is burned in the mixed material flow space, the combustion products forming during this combustion still contain sufficient air or oxygen that the conversion process can run in a suitable manner with subsequent introduction into the reformer arrangement together with the hydrocarbon vapor. It is advantageous here, for example, to produce a hypostoichiometric mixture ratio with a lambda value of about 0.4, whereby this mixture ratio refers to the ratio of air/hydrocarbon vapor in the mixing chamber and accordingly a corresponding ratio of air and anode exhaust gas must already be prepared beforehand for flowing through and combustion in the mixed material flow space.

Advantageously, provisions are furthermore made for the mixed material flowing through the mixed material flow space to be ignited and burned at least in a start phase of the reformer system. Thus, a cooling off of the reformer arrangement in the start phase of the reformer system can be avoided and same can be additionally heated, while, after the start phase, i.e., when the process temperature is essentially reached, heat can be removed from the area of the reformer arrangement.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic sectional view of a reformer system according to the present invention; and

FIG. 2 is a schematic sectional view of a fuel cell system including reformer system and fuel cell according to the present invention;

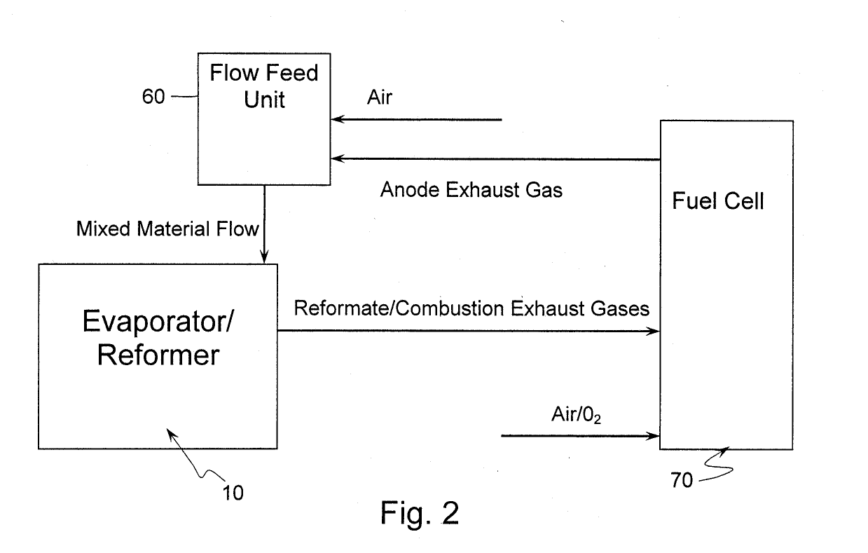

### DESCRIPTION OF THE PREFERRED EMBODIMENT

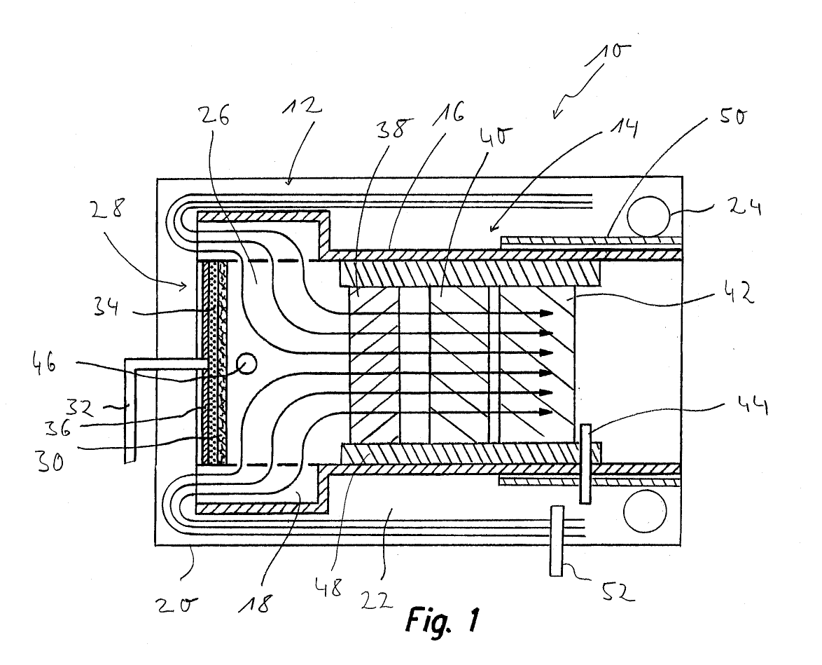

Referring to the drawings in particular, the present invention is explained in detail below with reference to the attached FIG. 1. A reformer system according to the present invention is generally designated by 10 in FIG. 1. This reformer system 10 may basically be organized into an evaporator area or an evaporator arrangement 12 and a reformer area or a reformer arrangement 14. The evaporator arrangement 12 and the reformer arrangement 14 may be arranged with their essential components in a common, tubular housing 16, which can be radially expanded for providing an annular introduction space 18 in the passage between the evaporator arrangement 12 and the reformer arrangement 14. This housing 16 is surrounded by an outer housing 20, so that a mixed material flow space 22 is formed in the area surrounding the reformer arrangement 14. Mixed material enters this flow space 22 via inlet openings 24, then flows along the reformer arrangement 14 and the outside of the evaporator arrangement 12 in order to reach a mixing chamber 26 after axial diversion into and then out of the annular introduction space 18.

This mixing chamber 26 is axially limited by a bottom component 28, which has a porous evaporator medium 30 on its side facing away from the mixing chamber 26. A fuel supply line feeds liquid fuel or hydrocarbon into this porous evaporator medium 30. An electrically energizable heating means 34 provided on the back side of the porous evaporator medium, which is carried at a carrier 36 with insulation, heats the porous evaporator medium 30 and thus contributes to the increased evaporation of the hydrocarbon in the direction of the mixing chamber 26. The hydrocarbon vapor thus generated is mixed in the mixing chamber 26 with the mixed material introduced into same and then reaches the area of the reformer arrangement 14. It should be pointed out here that this mixed material flow and also the flow of the mixture formed in the mixing chamber 26 can be generated by a mixed material blower 60 or another feeding arrangement.

In the reformer arrangement 14, the mixed material first flows through a flame retention baffle 38 and then reaches a first catalytic converter arrangement 40. In the direction of flow to the first catalytic converter arrangement 40 follows a second catalytic converter arrangement 42. As an alternative, a catalytic converter may be provided with two catalytic converter zones. A temperature sensor 44 is arranged downstream of the second catalytic converter arrangement 42. Furthermore, an ignition member 46 is assigned to the mixing chamber 26, which ignition member 46 protrudes into this mixing chamber 26 and, as will still be explained below, can ignite the mixture formed in the mixing chamber by means of energizing and can result in combustion.

The flame retention baffle 38, the first catalytic converter arrangement 40 and the second catalytic converter arrangement 42 are carried at the housing 16 via elastic material 48 in order to thus not transmit vibrations occurring during operation to these three components.

Furthermore, it is recognized that the reformer arrangement 14 or the housing 16 in that longitudinal area, in which the second catalytic converter arrangement 42 is arranged, is surrounded radially on the outside by a tubular or housing-like insulation element 50, so that the mixed material entering through the openings 24 in that area, in which the housing 16 is surrounded by the insulation element 50, essentially cannot enter into thermal interaction with the reformer arrangement 14, but rather only in the subsequent longitudinal section, in which essentially the first catalytic converter arrangement 40 is also arranged.

Furthermore, a second ignition member 52 is provided in the area of the mixed material flow space 22, which second ignition member 52 extends into this mixed material flow space 22 and, as explained below, can ignite and bring to combustion the mixed material flowing therein.

By incorporating a reformer system of this type into a fuel cell system with a fuel cell 70, a hydrogen-gas-containing reformate is thus generated by this reformer system 10, which can be used in a fuel cell together with air or atmospheric oxygen in order to generate electrical energy. The residual reformate leaving the fuel cell may, as so-called anode exhaust gas, be fed back to the reformer for better mixture formation by means of a feed unit (blower) 60 and then be thoroughly mixed with air or be introduced into the mixed material flow space 22 together with air via the openings 24, so that this mixture of air and anode exhaust gas essentially provides the previously already mentioned mixed material.

In a start phase of the fuel cell system, i.e., even in a start phase of the reformer system 10, it must, at first, be ensured that various system areas be brought to the suitable operating temperature. This concerns, above all, the two catalytic converter arrangements 40, 42, of which the first catalytic converter arrangement 40 is designed, such that essentially an exothermic catalytic reaction takes place there, while essentially an endothermic catalytic reaction takes place in the second catalytic converter arrangement. It is generally necessary to raise the temperature in the area of the catalytic converter arrangement 14 to an activation temperature of about 330° C. This may take place in the start phase by the mixture of hydrocarbon vapor and mixed material formed in the mixing chamber 26, essentially consisting of air in this case, being ignited and burned. The combustion exhaust gases leave the mixing chamber 26 and flow through the two catalytic converter arrangements 40, 42, whereby these quickly take up heat from the combustion exhaust gases and are brought to the operating temperature. In order to then start the reforming process, the combustion in the mixing chamber 26 is ended, for example, by means of a brief interruption of the fuel stream or of the hydrocarbon stream, so that a mixture of hydrocarbon vapor and air or mixed material is then forwarded into the two catalytic converter arrangements 40, 42 and starts the reforming process there. A reformate with increasingly rising hydrogen gas content then leaves the reformer system 10 and reaches the fuel cell. Above all, when the fuel cell proper is likewise not yet at operating temperature in this phase of operation and provided that the process for generating electrical energy was not yet started, the anode exhaust gas will have essentially the same composition as the reformate that leaves the fuel cell system 10. This residual reformate or anode exhaust gas is fed back or introduced into the mixed material flow space 22 together with air through the openings 24. Since the temperature of the two catalytic converter arrangements 40, 42 is comparatively low in this start phase and still lies distinctly below the optimal process temperature, the second ignition member 52 is electrically energized according to the present invention, so that in the area of the mixed material flow space, conditions are created, under which the mixed material is ignited and burned. The heat forming during this combustion heats the reformer arrangement 14 from outside and prevents the heat forming in the starting reforming process from being increasingly transmitted outwardly to the mixed material flowing in the mixed material flow space 22.

This leads to a distinctly faster increase in the temperature in the area of the reformer arrangement 14 and thus to a distinctly faster reaching of the suitable optimal process temperature.

Moreover, the mixture forming reaction in the mixing chamber experiences the corresponding educt preheating.

Not only to cool off less intensively or to heat even faster by heating the reformer arrangement 14 from the outside, but also to be able to prepare the conditions in the reformer arrangement 14 proper for carrying out a reforming process, it must be ensured that even after burning the mixed material in the mixed material flow space 22, a sufficient amount of air or atmospheric oxygen is still present in order to prepare a mixture suitable for the reforming process in the mixing chamber 26 with the hydrocarbon vapor. This mixture is preferably hypostoichiometric and should have a lambda value of about 0.4. I.e., the combustion in the mixed material flow space 22 is carried out with such an excess of air that a corresponding residual air or residual oxygen quantity can be guaranteed for the introduction into the mixing chamber 26.

After suitable thermal conditions for carrying out a stable reforming process are then created in the reformer arrangement 14 without the risk of generating hazardous components, such as, e.g., soot, the combustion in the mixed material flow space 22 is ended. This may take place, for example, by the air stream being briefly interrupted. Also, the ending of the energizing of the ignition member 52 may lead to the extinguishing of the combustion depending on the external conditions and also depending on the mixing ratio of the components of the mixed material. Subsequently, the comparatively cold or colder mixed material then flows through the mixed material flow space 22 and may in the next operation then remove heat from the area of the reformer arrangement 14, especially from the area of the first catalytic converter arrangement 40 and thus be forwarded into the mixing chamber 26 already preheated. Since in this normal operating phase, the mixed material then reaches the mixing chamber 26 with unchanged mixing ratio from the mixed material flow space 22, the air content or the atmospheric oxygen content can be reduced compared to the combustion phase, so that the hypostoichiometric mixture in the mixing chamber 26 is then again generated in conjunction with the evaporated hydrocarbon quantity.

With the present invention, it is possible in a simple manner to distinctly shorten the start phase of the reforming process in a reformer system. Since a heating of the mixed material is ensured both in the start phase and in the normal operating phase, namely either by combustion of same or by heat uptake by the reformer arrangement 14, the provision of additional heating means for the mixed material to be introduced into the mixing chamber can be eliminated.

It is a matter of course that the ignition or combustion of the mixed material can take place not only in that area of the mixed material flow space 22, in which this surrounds the reformer arrangement 14. Rather, with corresponding structural embodiment, the mixed material could also be ignited and burned already before the introduction to the reformer arrangement in another area, lying upstream, of the mixed material flow space and possibly also still before introduction through the openings 24, so that the heat forming during the combustion can be transmitted to the reformer arrangement 14 in case of further flow through that area of the mixed material flow space 22, which can also be seen in FIG. 1.

While specific embodiments of the invention have been shown and described in detail to illustrate the application of the principles of the invention, it will be understood that the invention may be embodied otherwise without departing from such principles.

What is claimed is:

1. A reformer system for generating a hydrogen-containing gas for a fuel cell system or a motor vehicle fuel cell system, the reformer system comprising:
an evaporator arrangement receiving hydrocarbon and mixed material for generating a hydrocarbon vapor/mixed material mixture;
a reformer arrangement with reformer catalytic converter material for converting the hydrocarbon vapor/mixed material mixture to hydrogen-containing gas;
a mixed material flow space surrounding a portion of said reformer arrangement for receiving at least a part of the mixed material to be introduced into said evaporator arrangement for flow therethrough and for the transmission of heat between said reformer arrangement and the mixed material; and
an ignition arrangement operatively assigned to said mixed material flow space for igniting and burning the mixed material flowing through said mixed material flow space.

2. A reformer system in accordance with claim 1, wherein a feed device is provided for feeding air and anode exhaust gas from a fuel cell system as mixed material or mixed material component through said mixed material flow space.

3. A process for operating a reformer system, the process comprising:
providing an evaporator arrangement receiving hydrocarbon and mixed material for generating a hydrocarbon vapor/mixed material mixture;
providing a reformer arrangement with reformer catalytic converter material for converting the hydrocarbon vapor/mixed material mixture to hydrogen-containing gas;
providing a mixed material flow space surrounding a portion of said reformer arrangement for receiving at least a part of the mixed material to be introduced into said evaporator arrangement for flow therethrough and for the transmission of heat between said reformer arrangement and the mixed material;
providing an ignition arrangement operatively assigned to said mixed material flow space for igniting and burning the mixed material flowing through said mixed material flow space;
burning process air and anode exhaust gas of a fuel cell system as mixed material or a mixed material component in said mixed material flow space;
forwarding the burned process air and anode exhaust gas or burned mixed material component to said evaporator arrangement, whereby air is supplied in excess in said process air with respect to said anode exhaust gas such that with subsequent thorough mixing of the air introduced into said evaporator arrangement with hydrocarbon vapor, a hypostoichiometric air/hydrocarbon vapor mixture ratio is generated.

4. A process in accordance with claim 3, wherein the hypostoichiometric mixture ratio with a lambda value of about 0.4 is generated in order to carry out a subsequent reforming of reformer catalytic converter material.

5. A process in accordance with claim 2, wherein in that the mixed material flowing through said mixed material flow space is ignited and burned at least during a start phase of said reformer system.

6. A system comprising:
an evaporator means for receiving hydrocarbon and mixed material for generating a hydrocarbon vapor/mixed material mixture;
a reformer with reformer catalytic converter material for converting the hydrocarbon vapor/mixed material mixture to hydrogen-containing gas;
a mixed material flow space disposed around a portion of said reformer arrangement for receiving at least a part of the mixed material to be introduced into said evaporator arrangement for flow therethrough and for the transmission of heat between said reformer arrangement and the mixed material; and
an ignition arrangement for igniting the mixed material flow space for igniting and burning the mixed material flowing through said mixed material flow space.

7. A system in accordance with claim 6, further comprising:
a fuel cell system providing an anode exhaust gas; and
a feed device for feeding air and the anode exhaust gas from the fuel cell system as mixed material or as a mixed material component through said mixed material flow space.

8. A system in accordance with claim 7, wherein said feed device in cooperation with said mixed material flow space and said ignition arrangement forwards burned process air and anode exhaust gas or burned mixed material component to said evaporator means, whereby air is supplied in excess in said process air and anode exhaust gas or in said mixed material component such that with subsequent thorough mixing of the air introduced into said evaporator arrangement with hydrocarbon vapor, a hypostoichiometric air/hydrocarbon vapor mixture ratio is generated.

9. A system in accordance with claim 8, wherein the hypostoichiometric mixture ratio with a lambda value of about 0.4 is generated in order to carry out a subsequent reforming of reformer catalytic converter material.

10. A system in accordance with claim 9, wherein mixed material flowing through said mixed material flow space is ignited and burned at least during a start phase of the system.
